(19) United States
(12) Patent Application Publication
(10) Pub. No.: US 2014/0112648 A1
(43) Pub. Date: Apr. 24, 2014

(54) AIR-HANDLING UNIT FOR USE IN A GREENHOUSE

(71) Applicant: Houweling Nurseries Oxnard, Inc., Camarillo, CA (US)

(72) Inventors: Geurt Reinders, Almelo (NL); Casey Houweling, Delta (CA)

(21) Appl. No.: 14/057,364

(22) Filed: Oct. 18, 2013

Related U.S. Application Data
(60) Provisional application No. 61/716,393, filed on Oct. 19, 2012.

(51) Int. Cl. A01G 9/14

(52) U.S. Cl. CPC A01G 9/14
USPC 392/347; 454/338

(57) ABSTRACT

An air-handling unit for use in a greenhouse. The unit provides an efficient, sturdy and easily assembled and transported means for drawing air and/or gas into a greenhouse air distribution conduit. The unit also provides an efficient means for adjusting the temperature of air drawn into air distribution conduits by the air handling unit by causing more incoming air to be exposed to an internal temperature-adjustment element. The unit comprises a housing body, an air inlet, an air outlet, a fan, and a temperature-adjustment element.

### CROSS REFERENCE TO RELATED APPLICATIONS

This application claims the benefit of U.S. Provisional Application Ser. No. 61/716,393 to Geurt Reinders, entitled AIR-HANDLING UNIT FOR USE IN A GREENHOUSE, filed on Oct. 19, 2012, which is hereby incorporated herein in its entirety by reference, including the drawings, charts, schematics, diagrams and related written description.

### BACKGROUND OF THE INVENTION

1. Field of the Invention

Described herein is a device relating to greenhouses, and specifically, air-handling units in greenhouses.

2. Description of the Related Art

Greenhouses have been used for hundreds of years to grow different varieties of plants, including ornamental plants and fruit/vegetable producing plants. Greenhouses typically comprise a structure with a plastic or glass roof and frequently glass or plastic walls. The interior of the greenhouse can be heated by incoming solar radiation that warms the plants and soil therein. The closed environment of a greenhouse has its own unique requirements compared with outdoor growing environments. Pests and diseases need to be controlled and irrigation is necessary to provide water. On the other hand, greenhouses can be arranged to compensate for extreme highs and lows of heat and humidity, and to generally control the environmental conditions such as the level of carbon dioxide (CO₂).

Different techniques have been developed to control the environmental conditions in a greenhouse. U.S. Pat. No. 5,001,859 to Sprung describes a method and structure for environmental control of plant growth in greenhouse conditions. The structure comprises a translucent stressed fabric shell on a base, the shell and base sealing the environment within the space against external environmental conditions. The temperature and relative humidity within the production areas are generally controlled by a microprocessor-based series of spray systems, along with a furnace. The spray systems can lower the temperature in the space while at the same time increasing humidity, and the furnace can be utilized to increase the temperature within the space.

U.S. Pat. No. 5,813,168 to Clendening describes a greenhouse and a method for controlling the environment of the interior space of the greenhouse. The greenhouse includes an interior insulating panel and a movable exterior reflective panel capable of both insulating the interior of the greenhouse and reflecting sunlight into the interior. The greenhouse also includes a closed-system heat exchanger having a plurality of spaced water-impermeable water flow passageways through which water flows by gravitational force, and having a means for blowing air between the water flow passageways such that the air does not contact the water and is either heated or cooled by the water. In addition, the heat exchanger may include a water and/or gas discharge for the control of humidity and gas levels within the greenhouse. Finally, the greenhouse includes hydroponic plant beds disposed on top of the heat exchangers and hydroponic solution tanks along the outer interior walls of the greenhouse.

U.S. Pat. No. 7,228,657 to Brault et al. discloses a greenhouse having an exterior curtain wall structure formed by spaced tubular posts carrying external transparent panels and bottom non-transparent wall panels below a sill with the panels spanning the posts. A plurality of elongate benches is located within the interior at spaced positions along one side wall with the width of the benches being equal to the post spacing to form an expandable construction. Each bench has associated with it a respective air handling system for conditioning, including a duct which is located partly under the respective bench and a fan in a fan housing at the side wall. From the fan, a vertical duct section extends to a flexible tube extending over the bench. Air dehumidification, fogging, heating and cooling are provided in the duct under the bench.

Typically, greenhouse distribution conduits utilize fans to draw air into the conduits. Furthermore, greenhouses may use a temperature-adjustment element such as a heater to adjust the temperature of air entering distribution conduits. However, typically, multiple fans must be used and these fans are often difficult to assemble and transport. Furthermore, the temperature-adjustment element may not efficiently interact with air drawn into the conduits by these fans.

### SUMMARY OF THE INVENTION

Described herein is an air-handling unit for use in a greenhouse, which provides an efficient means for drawing air and/or gas into a greenhouse air distribution conduit. The unit is sturdy and easily assembled and transported. The unit also provides an efficient means for adjusting the temperature of air drawn into air distribution conduits. The unit comprises a housing body, an air inlet, an air outlet, a fan, and a temperature-adjustment element.

One embodiment of an air handling unit incorporating features of the present invention comprises a body, at least one air inlet in the body, at least one fan arranged to draw air or gas into the body through the air inlet, at least one temperature-adjustment element angled in conjunction with the air inlet such that a substantial portion of the air or gas is exposed to the surface area of the temperature adjustment element, and at least one air outlet in the body through which the air or gas can exit the body.

Another embodiment of an air handling unit incorporating features of the present invention comprises a body which comprises a plurality of panels, where there is an air inlet in one of the panels, a fan arranged to draw air or gas into the body through the air inlet, a temperature-adjustment element angled in conjunction with the plurality of panels such that a substantial portion of the air or gas is exposed to the surface area of the temperature adjustment element, and at least one air outlet in the body through which the air or gas can exit the body.

An embodiment of greenhouse distribution system incorporating features of the present invention comprises a body, at least one air inlet in the body, at least one fan arranged to draw air or gas into the body through the air inlet, at least one temperature-adjustment element angled in conjunction with the air inlet such that a substantial portion of the air or gas is exposed to the surface area of the temperature adjustment element, at least one air outlet in the body through which the air or gas can exit the body, and a distribution conduit attached to the at least one air outlet.

These and other further features and advantages of the invention would be apparent to those skilled in the art from the following detailed description, taking together with the accompanying drawings, in which:

### BRIEF DESCRIPTION OF THE DRAWINGS

FIG. 1 is an exploded view of one embodiment of an air-handling unit according to the present invention;

FIG. 2 is a perspective view of one embodiment of an air-handling unit according to the present invention;

FIG. 3 is a side view of one embodiment of an air-handling unit according to the present invention;

FIG. 4 is a top view of one embodiment of an air-handling unit according to the present invention; and

FIG. 5 is a bottom view of one embodiment of an air-handling unit according to the present invention.

### DETAILED DESCRIPTION OF THE INVENTION

Embodiments incorporating features of the present invention are directed to air handling units and air or gas distribution systems. These systems can be utilized in a greenhouse and provide an efficient and cost-effective system for controlling greenhouse climate within a greenhouse growing section. Air handling units according to the present disclosure comprise a body, an air inlet, a temperature-adjusting element and an air outlet.

Air handling units according the present disclosure can be arranged such that a substantial portion of the air drawn into the air handling unit can become exposed to the temperature-adjustment element. This can be accomplished through the arrangement of the various components of the air handling unit. For example, the body and/or air inlet can be arranged such that incoming air is exposed to a greater surface area of the temperature-adjustment element. This and other arrangements are discussed further below.

The body of an air handling unit according the present disclosure can also comprise a small number of panels, for example, four panels, allowing the unit to be easily assembled and shipped to various locations. The panels themselves can also contribute to the directional control of both incoming and outgoing air, as will be discussed further below.

Throughout this description, the preferred embodiment and examples illustrated should be considered as exemplars, rather than as limitations on the present invention. As used herein, the term “invention,” “device,” “present invention” or “present device” refers to any one of the embodiments of the invention described herein, and any equivalents. Furthermore, reference to various feature(s) of the “invention,” “device,” “present invention” or “present device” throughout this document does not mean that all claimed embodiments or methods must include the referenced feature(s).

It is also understood that when an element or feature is referred to as being “on” or “adjacent” another element or feature, it can be directly on or adjacent the other element or feature or intervening elements or features may also be present. Furthermore, relative terms such as “outer”, “above”, “lower”, “below”, and similar terms, may be used herein to describe a relationship of one feature to another. It is understood that these terms are intended to encompass different orientations in addition to the orientation depicted in the figures.

It is also understood that when an element is referred to as being “connected,” “attached” or “coupled” to another element, it can be directly connected, attached or coupled to the other element or intervening elements may be present. In contrast, when an element is referred to as being “directly connected,” “directly attached” or “directly coupled” to another element, there are no intervening elements present.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

The devices described herein can be used in greenhouses utilizing distribution conduits, such as air or gas distribution conduits which terminate in the growing section of the greenhouse. An example arrangement of such conduits can be found in US Pre-Grant Publications US 2008/0000151 A1 to Houweling, et al., filed on Jun. 28, 2007 and US 2010/0126062 A1 to Houweling, et al., filed on Dec. 11, 2009, which are hereby incorporated in their entirety by reference. The drawings, figures and their corresponding written descriptions set forth examples of greenhouses and greenhouse distribution conduits that can utilize devices as described herein.

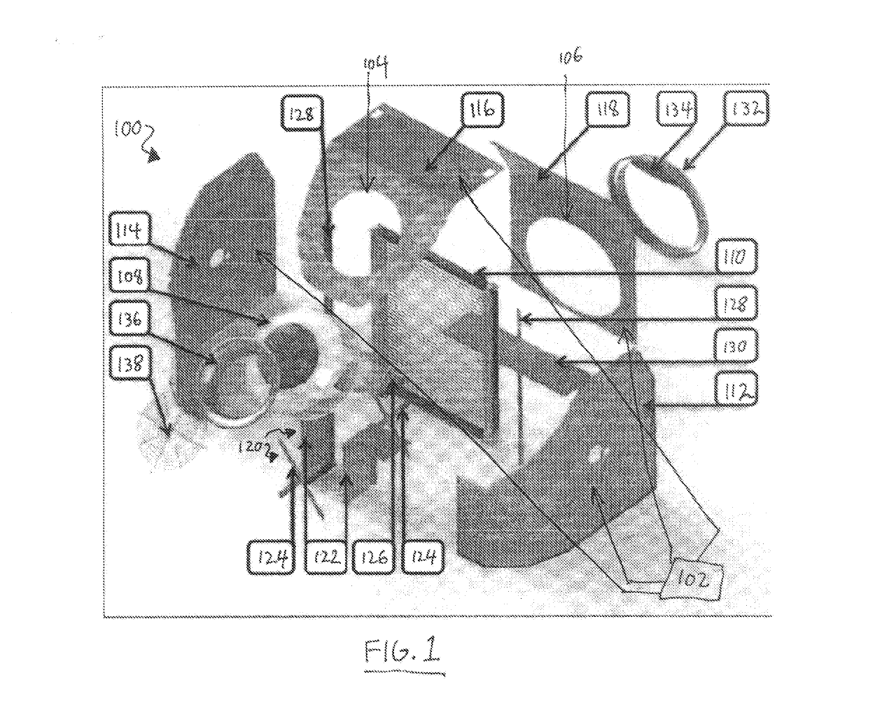

FIG. 1 shows an exploded view of one embodiment of an air-handling unit according to the present invention. Air-handling unit 100 comprises a body 102, at least one air inlet 104, at least one air outlet 106, at least one fan 108 and at least one temperature-adjustment element 110. Body 102 can comprise four panels which are assembled together: left air-bend panel 112, right air-bend panel 114, air inlet panel 116, and air outlet panel 118. Panels 112, 114, 116 and 118 can be made of any resilient material with the preferred material being metal.

The number of panels required to assemble body 102 is preferably limited. Limiting the number of panels provides several advantages. For example, the amount of material required to assemble air-handling unit 100 is reduced, making air-handling unit 100 easier and more economical to build; this includes both the amount of material for the panels (e.g. sheet metal) as well as connective features for attaching the panels to one another (e.g., nuts and bolts). Furthermore, by having the body comprise fewer panels, air-handling unit 100 has fewer components and required connections between these components, resulting in increased structural integrity.

Fan 108 can be a structural component of air-handling unit 100, or can be a loose component, with air-handling unit 100 built around the fan. Fan 108 can be any mechanism that is capable of drawing air into air-handling unit 100 and/or a distribution conduit. Fan 108 can be anchored into the ground or attached to a portion of body 102 via a fan mounting mechanism 120. Fan mounting mechanism 120 can comprise a fan support mount 122 and at least one cross-mount component 124 (two shown). Cross mount component 124 provides additional support for fan mounting mechanism 120. The support mount 122 can be a single piece of material or can comprise multiple pieces of material with cross-mount component 124 connecting them. In some embodiments, fan mounting mechanism 120 can be anchored into the ground.

Fan mounting mechanism 120 can further comprise a fan flange 126. Fan flange 126 can be used to attach fan 108 to fan mounting mechanism 120. Fan flange 126 can provide additional support and stability to fan 108 and can provide an additional means of adjusting and securing the position and alignment of fan 108. In one embodiment, fan flange 126 can be configured or arranged to attach to an external motor portion of fan 108.

Due to the positioning of the fan in relation to the other components of air-handling unit 100, a single fan of sufficient power can be used to efficiently draw air into distribution conduits in communication with air-handling unit 100 and to efficiently adjust the temperature of the air as needed. Temperature adjustment is accomplished with temperature-adjustment element 110 which interacts with, and can adjust the temperature of, air drawn into air handling unit 100. In one embodiment, temperature-adjustment element 110 is a heating coil. Temperature-adjustment element 110 can be a structural component of air-handling unit 100 and can be configured to more fully interact with air drawn in to air-handling unit 110 as will be discussed in further detail below. Temperature-adjustment element 110 can be externally controlled. In one embodiment, temperature-adjustment element 110 can be monitored or controlled by an external system such as a computer. In another embodiment, temperature-adjustment element can simply have an on and off state which can be adjusted according to the air-temperature needs of a greenhouse.

Temperature-adjustment element 110 can be further secured and/or attached to the interior of body 102 via at least one restraint element 128 (two shown) and/or at least one bottom support sheet 130. Restraint elements 128 and bottom support sheet 130 can provide additional support or structural integrity to temperature-adjustment element 110 and can also assist in the alignment of temperature-adjustment element 110 in relation to the other components of air-handling unit 100.

Distribution conduits, such as air or gas distribution conduits, can be attached to air outlet 106. Air outlet panel 118 can further comprise an outlet ring 132 which can assist in facilitating the attachment of air distribution conduits to air outlet 106. Outlet ring 132 can be used to secure an air distribution conduit to air outlet panel 118 and can provide an airtight seal at the junction where an air distribution conduit connects to air outlet 106.

Outlet ring 132 can further comprise an air-guide portion 134 with can assist in stabilizing the airflow from air-handling unit 100 as it is conveyed to an attached distribution conduit. Air-guide portion 134 can be a separate component, can be attached and integrated into outlet ring 132, or can be part of outlet ring 132 itself. Air-guide portion 134 can direct air by adjusting and/or altering the direction of airflow from air outlet 106 to an attached distribution conduit. Air-guide portion 134 can also narrow the effective diameter of air outlet 106 and be used to adjust the speed, pressure and/or direction of exiting air.

The various components of air-handling unit 100 are configured in conjunction with one another to efficiently direct air-flow through the unit and expose a substantial portion of the drawn-in air to temperature-adjustment element 110. Air inlet panel 116 is configured in relation to left and right air-bend panels 112 and 114 such that air inlet 104 is arranged at an angle which directs drawn-in air towards temperature-adjustment element 110. In comparison with prior art techniques, this results in a greater percentage of the air drawn into air-handling unit 100 being directed toward and exposed to temperature adjustment element 110, due to the air interacting with a greater amount of the surface area of temperature adjustment element 110. If air inlet 104 was simply at a 90° angle on the top of air-handling unit 100, the drawn in air would be exposed to less of the surface area of temperature-adjustment element 110. Here, fan 108 is aligned with air inlet 104 and positioned in relation to temperature adjustment element 110 such that air drawn in to air handling unit 100 is exposed to more of the surface area of temperature adjustment element 110. Air outlet 106 is also configured in relation to temperature adjustment element 110 such that a substantial portion of air exposed to temperature adjustment element 110 exits into the distribution conduits.

Air-handling unit 100 can further comprise a düse 136 to further control the direction of air entering air-handling unit 100. Düse 136 can comprise a ring having a tapered diameter like a funnel. Düse 136 attaches to and/or is in communication with air inlet 104. Düse 136 can further direct air toward fan 108 and temperature-adjustment element 110 by providing an air-funneling action. Düse 136 can be attached to air-inlet 104 via sealant, thus ensuring more air is directed toward temperature-adjustment element 110.

Air-handling unit 100 can further comprise a guard grill 138. Guard grill 138 can cover air inlet 104 and serves to block and prevent larger debris from entering air-handling unit 100 and damaging its internal components. The guard grill can be placed on the düse 136.

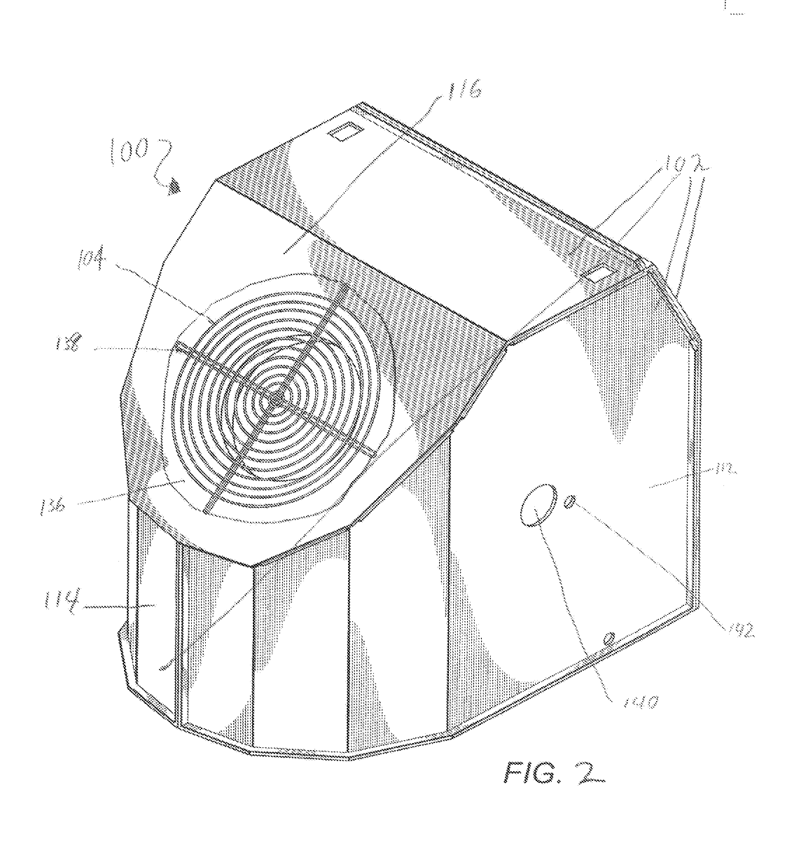

FIG. 2 shows a perspective view of a complete assembled air-handling unit 100. Air-handling unit 100 can comprise one or more maintenance access portions 140 (one shown) which can provide external access to the internal components such as fan 108 and temperature-adjustment element 110. Maintenance access portion 140 can be on any part of body 102 and can be positioned in relation to a certain internal component, such as fan 108, and allows for routine maintenance of the internal components without necessitating complete disassembly of the unit.

In one embodiment, maintenance access portion 140 is a simple hole. This streamlines the manufacture of air-handling unit 100, reducing costs and eliminating the need to install a more complex maintenance access portion. In other embodiments maintenance access portion 140 may be more complex, comprising an openable and closeable portion of the panel on which it is installed. Various means of opening and closing maintenance access portion 140 can be used, including but not limited to: latches, hinges, removable portions and/or sliding panels.

Air handling unit 100 can also comprise one or more electrical access portions 142 (one shown) which can provide external electrical connections to the internal components such as fan 108 and temperature-adjustment element 110. Electrical access portion 142 can be on any part of body 102 and can be positioned in relation to a certain internal component, such as fan 108, and allows for electrical access to the internal components so that they might be, e.g., powered or electrically or electronically controlled.

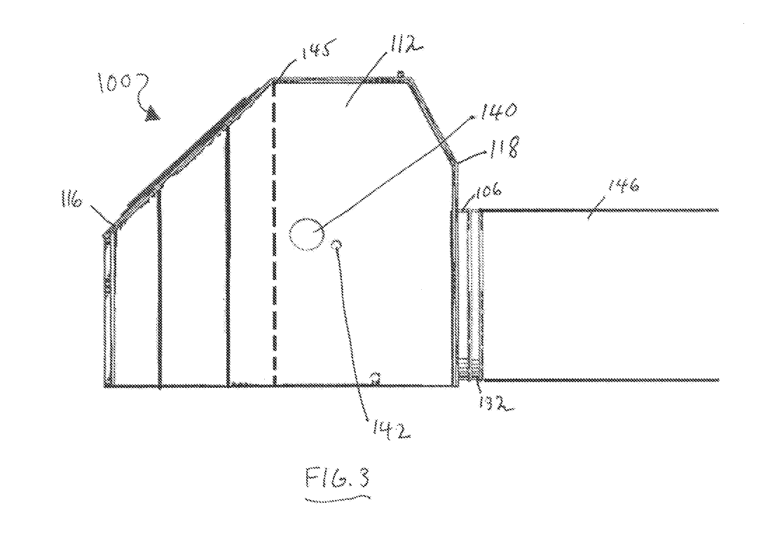

FIG. 3 is a side view of a complete assembled air-handling unit 100. This view shows the angle of air inlet panel 116 in relation to outlet panel 118, left air-bend panel 112 and temperature adjustment element 110 (the position of which is shown by phantom line 145). It is understood that while temperature adjustment element is shown in the position depicted in FIG. 3, many other positions of temperature adjustment element 110 are possible that allow for incoming air to be exposed to a substantial portion of its surface area as is discussed above, for example, placing it closer to air inlet panel 116 or at varying positions between air inlet panel 116 and the ground. FIG. 3 also depicts a distribution conduit 146 attached to the air outlet 106 via outlet ring 132.

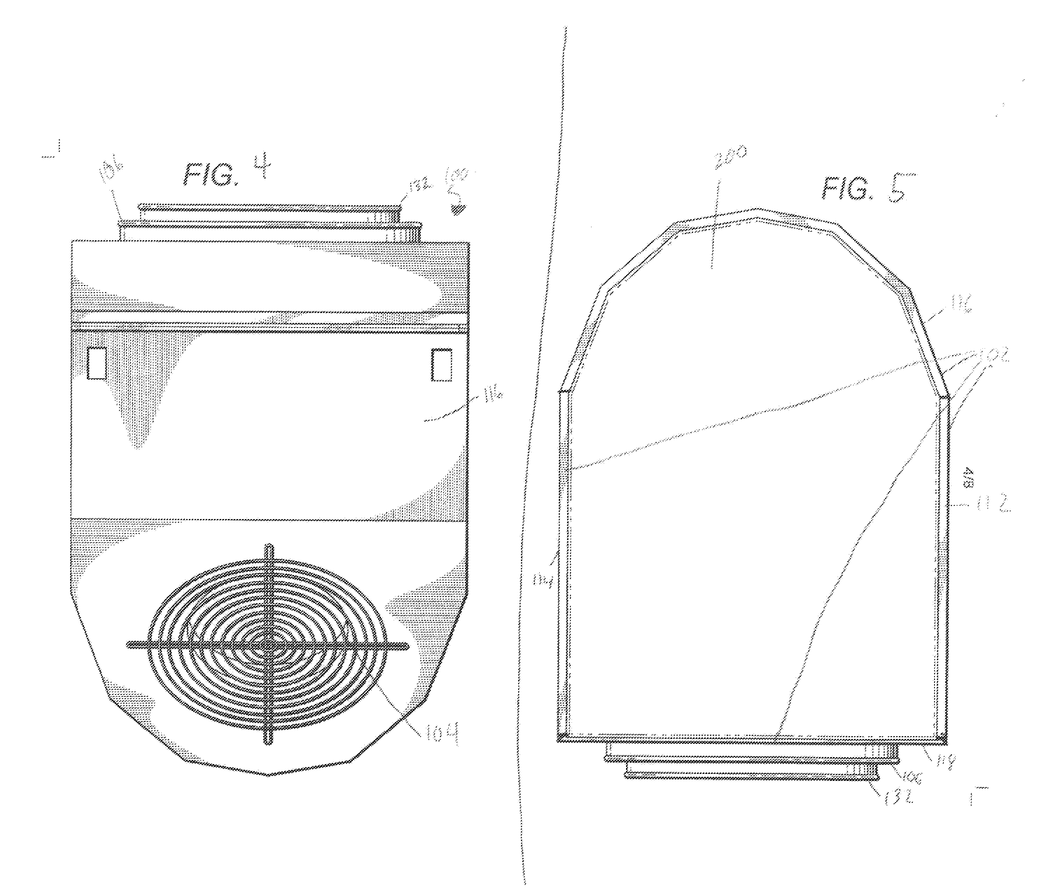

FIGS. 4 and 5 show additional views of air handling unit 100. FIG. 4 is a top view of a complete assembled air-handling unit 100 depicting air inlet 104, inlet panel 116, outlet 106 and outlet ring 132. FIG. 5 is bottom view of a complete assembled air-handling unit 100 depicting air outlet 106, left air-bend panel 112, right air-bend panel 114, air inlet panel 116, air outlet panel 118, and outlet ring 132. FIG. 5 also shows the bottom area 200 of air handling unit 100. The bottom area 200 can be open (as shown) allowing the air handling unit's body 102 to fit around a ground-anchored fan and easily be displaced and replaced, for example, to simplify fan access and maintenance. The bottom area 200 can also be closed, for example, by utilizing another panel, such that the fan and other internal components are complete surrounded. This arrangement can allow for additional protection of the fan and other internal elements from adverse environmental factors.

Although the present invention has been described in detail with reference to certain preferred configurations thereof, other versions are possible. Therefore, the spirit and scope of the invention should not be limited to the versions described above.

I claim:

1. An air handling unit, comprising:
a body;
at least one air inlet in said body;
at least one fan arranged to draw air or gas into said body through said air inlet;
at least one temperature-adjustment element, said air inlet arranged to direct said air or gas toward said temperature adjustment element, said air inlet angled with said temperature adjustment element such that a substantial portion of said air or gas is exposed to the surface area of said temperature adjustment element; and
at least one air outlet in said body through which said air or gas exits said body.

2. The air handling unit of claim 1, wherein said body comprises four panels.

3. The air handling unit of claim 2, wherein said four panels comprise an air inlet panel, an air outlet panel and right and left air bend panels.

4. The air handling unit of claim 3, wherein said air inlet panel is configured in conjunction with said right and left air bend panels such that a substantial portion of said air or gas is exposed to said temperature adjustment element.

5. The air handling unit of claim 1, wherein said at least one fan is anchored into the ground and said body is around said at least one fan.

6. The air handling unit of claim 1, wherein said at least one fan is attached to said body.

7. The air handling unit of claim 1, wherein the position of said at least one fan is adjustable.

8. The air handling unit of claim 1, comprising a single fan.

9. The air handling unit of claim 1, wherein said at least one temperature-adjustment element comprises a heating coil.

10. The air handling unit of claim 1, wherein said at least one air outlet further comprises an outlet ring configured to facilitate attachment of a distribution conduit to said at least one air outlet.

11. The air handling unit of claim 1, wherein said at least one air outlet further comprises an air-guide portion for adjusting the direction of said air or gas as it exits said at least one air outlet.

12. The air handling unit of claim 1, further comprising a düse arranged to control the direction of said air entering into said at least one air inlet.

13. The air handling unit of claim 1, further comprising a guard grill on said düse.

14. The air handling unit of claim 1, further comprising at least one maintenance access portion.

15. The air handling unit of claim 1, wherein the angle between said air inlet and said temperature adjustment element is less than 90 °.

16. An air handling unit, comprising:
a body comprising a plurality of panels;
an air inlet in one of the panels in said plurality of panels;
a fan, said fan arranged to draw air or gas into said body through said air inlet;
a temperature-adjustment element, wherein said plurality of panels is arranged to direct said air or gas toward said temperature adjustment element, said plurality of panels angled with said temperature adjustment element such that a substantial portion of said air or gas is exposed to the surface area of said temperature adjustment element; and
an air outlet in one of said panels in said plurality of panels through which said air or gas exits said body.

17. The air handling unit of claim 16, wherein said fan is anchored into the ground and said body is around said fan.

18. The air handling unit of claim 16, wherein said fan is attached to said body.

19. The air handling unit of claim 16, wherein the position of said fan is adjustable.

20. The air handling unit of claim 16, comprising a single fan.

21. The air handling unit of claim 16, wherein said temperature-adjustment element comprises a heating coil.

22. The air handling unit of claim 16, wherein said air outlet further comprises an outlet ring configured to facilitate attachment of a distribution conduit to said air outlet.

23. The air handling unit of claim 16, wherein said air outlet further comprises an air-guide portion for adjusting the direction of said air or gas as it exits said air outlet.

24. A greenhouse distribution system, comprising:
a body;
at least one air inlet in said body;
at least one fan, said at least one fan arranged to draw air or gas into said body through said air inlet;
at least one temperature-adjustment element, said air inlet arranged to direct said air or gas toward said temperature adjustment element, said air inlet angled with said temperature adjustment element such that a substantial portion of said air or gas is exposed to the surface area of said temperature adjustment element;
at least one air outlet through which said air or gas exits said body;
a distribution conduit attached to said at least one air outlet.

25. The distribution system of claim 24, wherein said at least one air outlet further comprises an outlet ring configured to facilitate attachment of a distribution conduit to said at least one air outlet.

26. The distribution system of claim 25, wherein said outlet ring further comprises an air-guide portion for adjusting the direction of said air or gas as it exits said at least one air outlet.
